(19) United States
(12) Patent Application Publication
(10) Pub. No.: US 2026/0296679 A1
(43) Pub. Date: Oct. 1, 2026

(54) Adapter System for a CubeSat Deployer

(71) Applicant: Arrow Science and Technology

(72) Inventors: James Dwight Baker, Pearland, TX (US); Mark David Rowley, Friendswood, TX (US)

(21) Appl. No.: 19/205,158

(22) Filed: May 12, 2025

Related U.S. Application Data
(63) Continuation-in-part of application No. 29/996,325, filed on Mar. 31, 2025.

(51) Int. Cl. B64G 1/22

(52) U.S. Cl. CPC B64G 1/2229

(57) ABSTRACT

An adapter system for a CubeSat deployer is a system that enables a CubeSat to be transported by any CubeSat deployer even if the CubeSat specifications do not match the CubeSat deployer specifications. The system includes one or more CubeSat adapters. Each CubeSat adapter includes an elongated prismatic body, a CubeSat engagement feature, and a deployer engagement feature. The elongated prismatic body corresponds to the main structure of the corresponding CubeSat adapter with a shape and size designed to fill the corresponding empty space between the CubeSat and the CubeSat deployer. The overall weight of the elongated prismatic body also depends on the necessary weight that needs to be added to the system to accomplish the initially manifested mass and center of gravity. The CubeSat engagement feature corresponds to the portion that engages the CubeSat, while the deployer engagement feature corresponds to the portion that engages the CubeSat deployer.

### CROSS-REFERENCE TO RELATED APPLICATION

The current application is a continuation-in-part (CIP) application of the U.S. design application serial number 29/996,325 filed on Mar 31, 2025.

### FIELD OF THE INVENTION

The present invention relates generally to CubeSats and CubeSat deployment equipment. More specifically, the present invention discloses an adapter system that enables a CubeSat deployer to accommodate CubeSats of various designs.

### BACKGROUND OF THE INVENTION

The California Polytechnic State University (Cal-Poly) CubeSat Design Specification has established standard dimensions for CubeSats as well as the deployers used to launch and deploy CubeSats. Current common CubeSat sizes are 1U, 2U, 3U, 6U, and 12U as defined in the CubeSat Design Specification. Other CubeSat sizes not yet defined in the CubeSat Design Specification include 8U and 16U.

Orbital rocket launch providers require satellite launch customers to provide spacecraft and deployment mechanism data early in the launch campaign. This data includes items such as Computer Aided Design (CAD) models, mass properties data, finite element models, among other things. This information serves as the foundation for the launch provider to develop the launch configuration, calculate mass properties, perform loads analyses, and develop flight control system inputs.

Late changes in satellite manifest, size, mass, etc., can have a very serious effect on the launch provider as late changes affect the foundation upon which the launch provider work was performed. Quite often, the launch provider de-manifests a late satellite and launches ballast instead to minimize overall effects on launch workload and schedule.

Under certain circumstances, some satellite launch customers such as national defense agencies may need to make a late substitution (i.e., removing CubeSat “A” from the launch and replacing CubeSat “A” with CubeSat “B”). Normally, rocket launch providers would be very resistant to make such a change, for the reasons previously described. Therefore, there is a need for means to reduce or eliminate many of the negative effects on the launch provider due to late manifest changes.

### SUMMARY OF THE INVENTION

The present invention discloses an adapter system for a CubeSat deployer. The present invention enables a CubeSat to fit in a CubeSat deployer of different specifications to reduce or eliminate negative effects on the launch provider due to late manifest changes. In an exemplary embodiment, a 16U CubeSat is initially manifested with a 16U deployer to launch to orbit. At some later date, the CubeSat owner elects to replace the 16U CubeSat with a 3U CubeSat, which would make the 16U CubeSat deployer incompatible. The present invention allows the 16U CubeSat deployer to be retained in the launch manifest, with the 16U CubeSat replaced by a 3U CubeSat and the adapter system of the present invention.

Further, the adapter system of the present invention serves to position the smaller 3U CubeSat within the 16U deployer volume, as well as adding mass as required to adjust the mass and center of gravity of the new configuration so that the adjusted mass and center of gravity matches the mass and center of gravity of the replaced configuration. Furthermore, the adapter system of the present invention can accommodate different external features of the CubeSat as well as the different internal features of the CubeSat deployer. Additional features and benefits of the present invention are further discussed in the sections below.

### BRIEF DESCRIPTION OF THE DRAWINGS

FIG. 1 is a bottom-front-left perspective view of a CubeSat adapter of the present invention.

FIG. 2 is a top-rear-right perspective view of the present invention thereof.

FIG. 3 is an enlarged front view of the present invention thereof.

FIG. 4 is a left view of the present invention thereof.

FIG. 5 is an enlarged vertical cross-sectional view taken along line 5-5 in FIG. 4.

FIG. 6 is a top-rear-left perspective view of the present invention, wherein a pair of CubeSat adapters of the present invention are shown attached to a CubeSat.

FIG. 7 is a left view of the present invention thereof.

FIG. 8 is an enlarged front view of the present invention, wherein the CubeSat is shown enclosed by the present invention in a primed configuration.

FIG. 9 is a top-front-left perspective view of the present invention thereof.

FIG. 10 is a top-front-right perspective view of the present invention, wherein the present invention in the primed configuration is shown within a CubeSat deployer.

FIG. 11 is a top-front-right perspective view of the present invention, wherein the present invention is shown in a deployed configuration.

FIG. 12 is a left view of the present invention thereof, wherein the present invention is shown with a plurality of debris-preventing tethers.

FIG. 13 is a left view of the present invention thereof, wherein the present invention is shown with at least one deployer-anchoring tether.

### DETAILED DESCRIPTION OF THE INVENTION

All illustrations of the drawings are for the purpose of describing selected versions of the present invention and are not intended to limit the scope of the present invention.

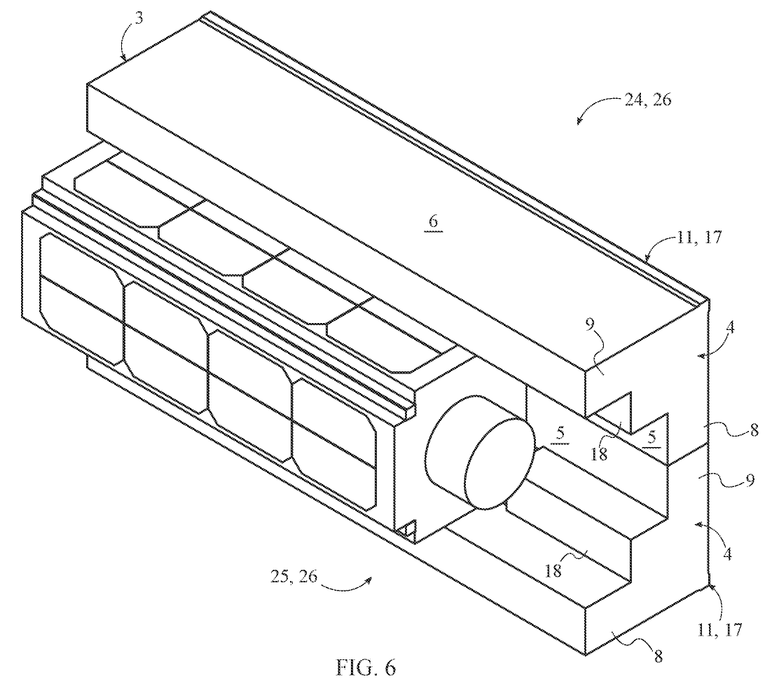

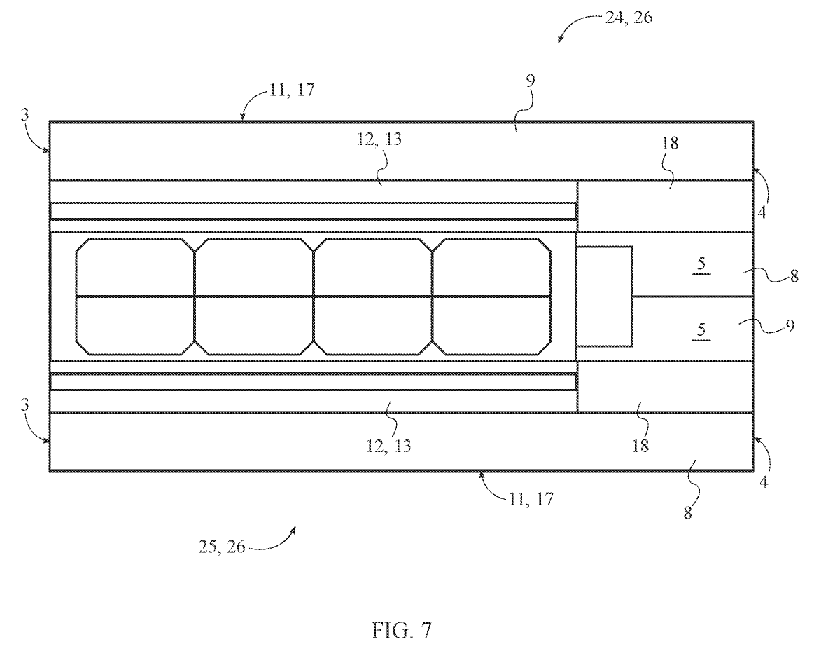

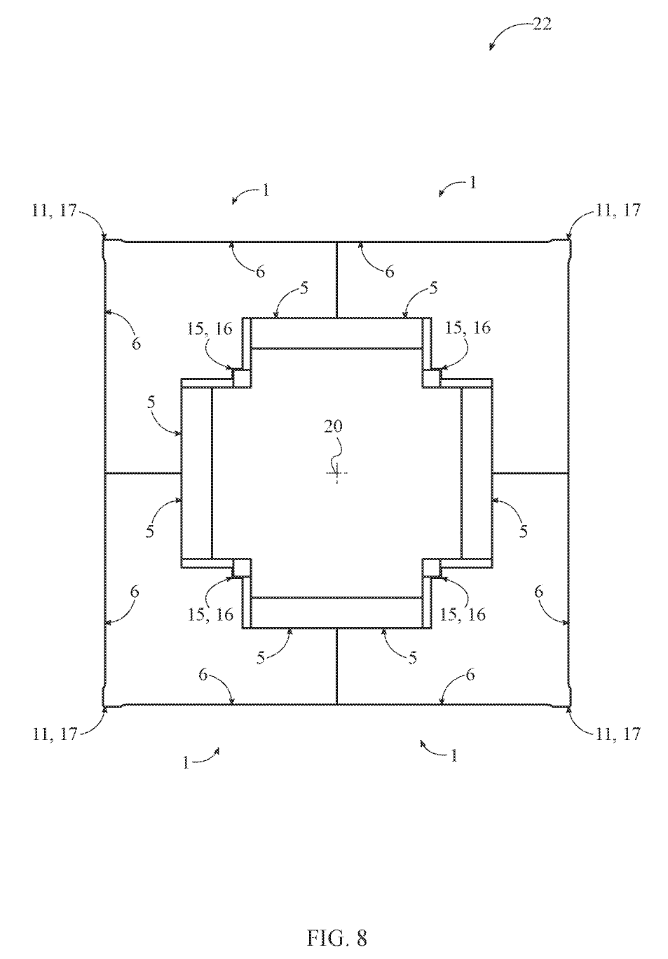

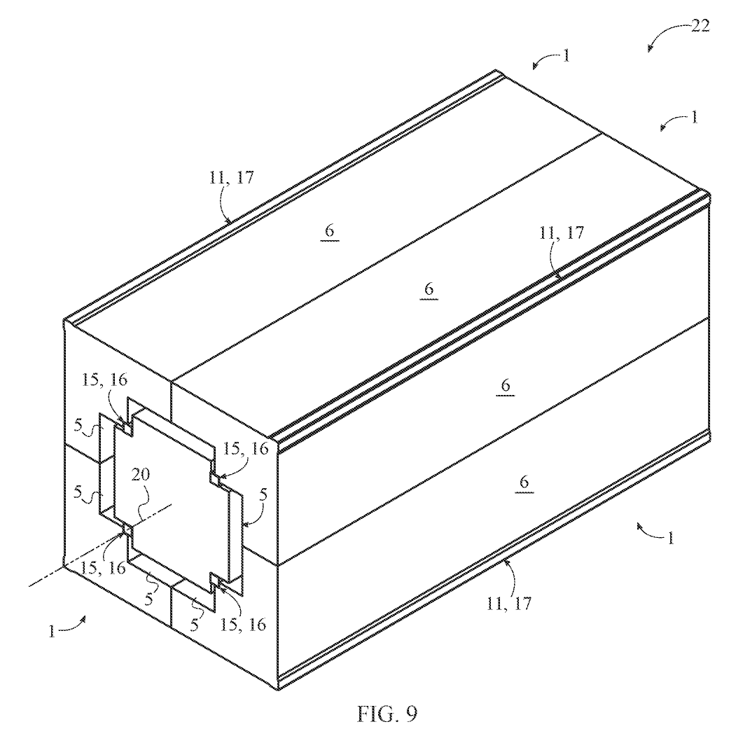

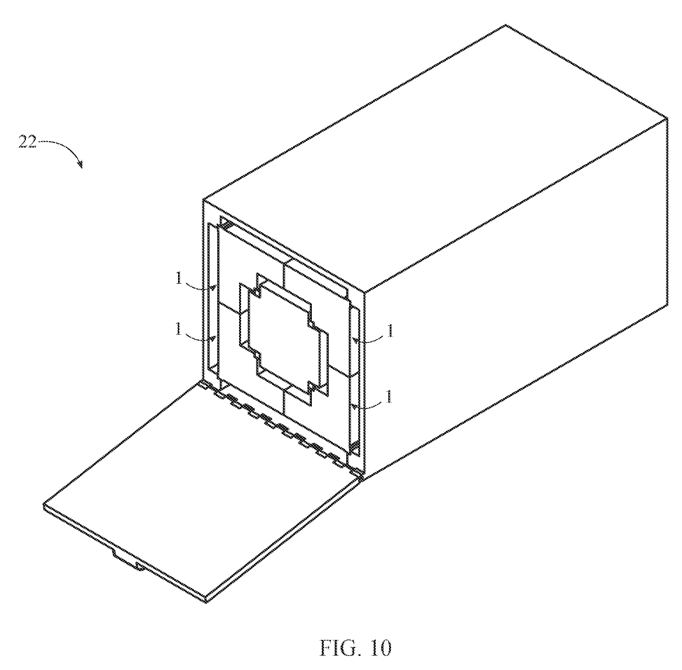

The present invention discloses an adapter system for a CubeSat deployer that enables any CubeSat deployer to accommodate a CubeSat of different specifications. As can be seen in FIGS. 6 through 13, the present invention comprises a plurality of CubeSat adapters 1 that enables the CubeSat to be transported by the CubeSat deployer even if the CubeSat specifications do not match the CubeSat deployer specifications. To do so, each of the plurality of CubeSat adapters 1 comprises an elongated prismatic body 2, a CubeSat engagement feature 12, and a deployer engagement feature 17.

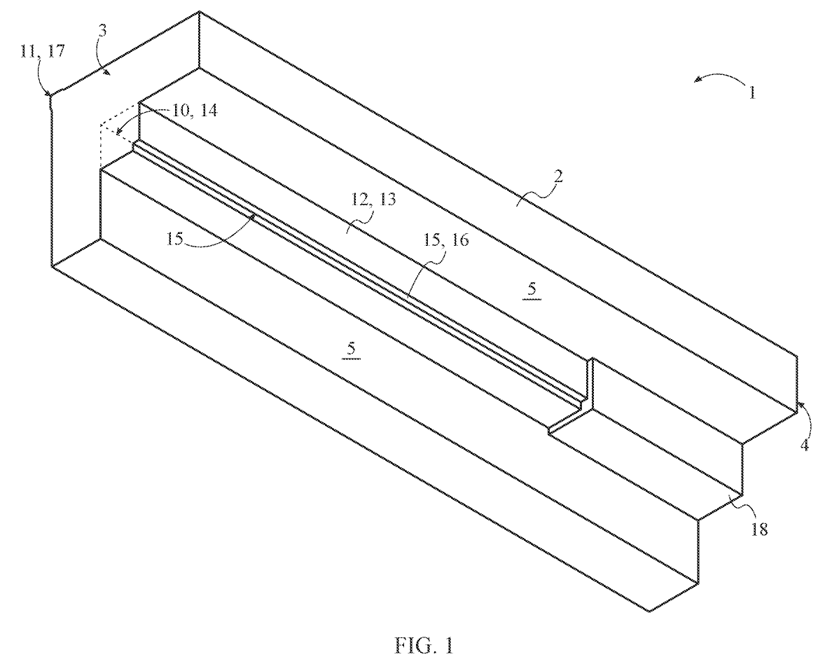

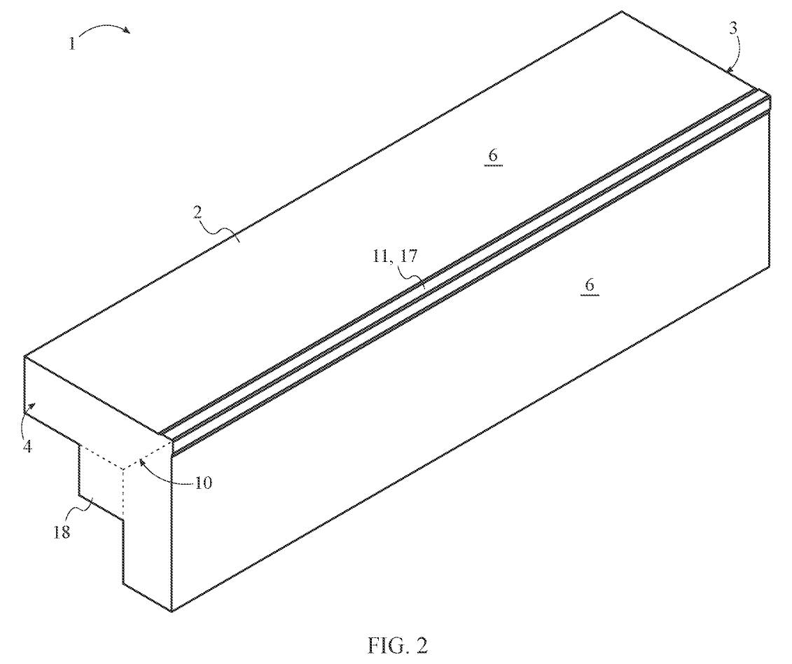

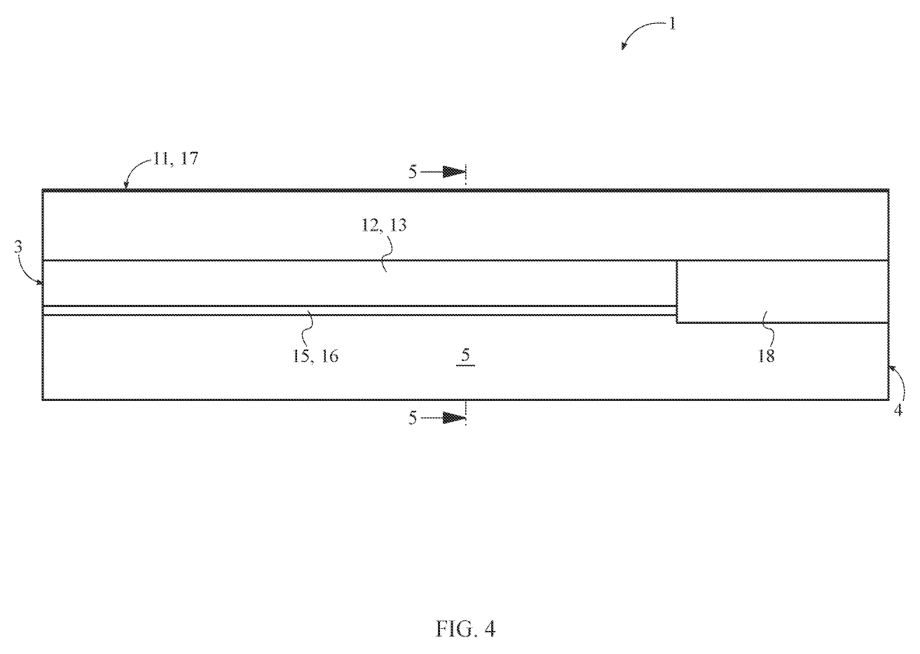

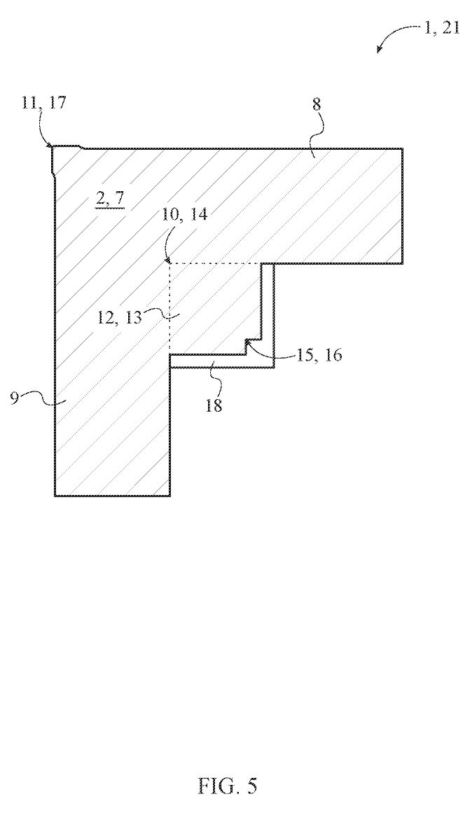

As can be seen in FIGS. 1 through 5, the elongated prismatic body 2 corresponds to the main structure of the corresponding CubeSat adapter. The shape and size of each elongated prismatic body 2 is designed to fill the corresponding empty space between the CubeSat and the CubeSat deployer. The overall weight of the elongated prismatic body 2 also depends on the necessary weight that needs to be added to the overall structure to accomplish the initially manifested mass and center of gravity. Further, the CubeSat engagement feature 12 corresponds to the portion of the corresponding CubeSat adapter that engages the CubeSat, while the deployer engagement feature 17 corresponds to the portion of the corresponding CubeSat adapter that engages the CubeSat deployer.

Each of the plurality of CubeSat adapters 1 is designed to match the internal structure design of the CubeSat deployer as well as the external structure design of the CubeSat, as can be seen in FIGS. 6 through 13. In general, the elongated prismatic body 2 has an overall rectangular design that matches the internal rectangular design of the CubeSat deployer as well as the external rectangular design of the CubeSat. So, the elongated prismatic body 2 comprises a first body end 3, a second body end 4, a CubeSat engagement surface 5, and a deployer engagement surface 6. The first body end 3 and the second body end 4 correspond to the two terminal ends of the elongated prismatic body 2. The CubeSat engagement surface 5 corresponds to the surface of the elongated prismatic body 2 that engages the corresponding external portion of the CubeSat. The deployer engagement surface 6 corresponds to the surface of the elongated prismatic body 2 that engages the corresponding internal portion of the CubeSat deployer.

In the preferred embodiment, the present invention can be arranged as follows: the CubeSat engagement surface 5 and the deployer engagement surface 6 are laterally positioned along the elongated prismatic body 2, as can be seen in FIGS. 1 through 5. The CubeSat engagement surface 5 and the deployer engagement surface 6 correspond to the two largest opposite surfaces of the corresponding elongated prismatic body 2. So, the CubeSat engagement surface 5 and the deployer engagement surface 6 are positioned opposite to each other about the elongated prismatic body 2. Further, the CubeSat engagement feature 12 is centrally mounted along the CubeSat engagement surface 5 to make the CubeSat engagement part of the elongated prismatic body 2. Similarly, the deployer engagement feature 17 is centrally mounted along the deployer engagement surface 6 to make the deployer engagement feature 17 part of the elongated prismatic body 2. Further, the elongated prismatic body 2 for each of the plurality of CubeSat adapters 1 is positioned parallel with a central CubeSat-traversing axis 20. Due to the rectangular design of the CubeSat deployer and the CubeSat, the plurality of CubeSat adapters 1 is preferably arranged around the CubeSat within the CubeSat deployer. So, the elongated prismatic body 2 for each of the plurality of CubeSat adapters 1 is radially distributed about the central CubeSat-traversing axis 20. Thus, the CubeSat is surrounded by the plurality of CubeSat adapters 1 when positioned within the CubeSat deployer so that the CubeSat meets the initial manifest specifications.

As previously discussed, the elongated prismatic body 2 of each of the plurality of CubeSat adapters 1 is designed to match the external rectangular design of the CubeSat, as can be seen in FIGS. 1 through 13. In the preferred embodiment, each elongated prismatic body 2 is designed to engage a corner of the CubeSat within the CubeSat deployer. To do so, a transversal cross-section 21 of the elongated prismatic body 2 is an angle shape 7 to match the corresponding external corner of the CubeSat. In addition, the angle shape 7 of the transversal cross-section 21 of the elongated prismatic body 2 results in the formation of a first leg 8 and a second leg 9. The angle shape 7 is preferably a right-angled shape so that the first leg 8 and the second are connected perpendicular and adjacent to each other. In other embodiments, the transversal cross-section 21 of the elongated prismatic body 2 can be different shapes that match various external shapes of the CubeSat.

The plurality of CubeSat adapters 1 is further designed so that the deployment of the enclosed CubeSat is not obstructed by the plurality of CubeSat adapters 1. In the preferred embodiment, the plurality of CubeSat adapters 1 can be arranged in a primed configuration 22 prior to launch, as can be seen in FIGS. 6 through 10. In the primed configuration 22, the plurality of CubeSat adapters 1 and the CubeSat are arranged within the CubeSat deployer so that the assembled system can be launched into space. The primed configuration 22 generally involves the second leg 9 of an arbitrary CubeSat adapter 24 being positioned parallel and against the first leg 8 of an adjacent CubeSat adapter 25. The arbitrary CubeSat adapter 24 and the adjacent CubeSat adapter 25 are any adjacent pair of CubeSat adapters 26 from the plurality of CubeSat adapters 1. This arrangement is repeated until the plurality of CubeSat adapters 1 enclose the CubeSat within the CubeSat deployer. For example, due to the rectangular shape of both the CubeSat and the CubeSat deployer, four CubeSat adapters are utilized to fully enclose the CubeSat within the CubeSat deployer. Each of the four CubeSat adapters engage a lateral corner of the CubeSat, which results in the CubeSat being centered within the CubeSat deployer. In other embodiments, different arrangements can be implemented in the primed configuration 22 due to different CubeSat designs.

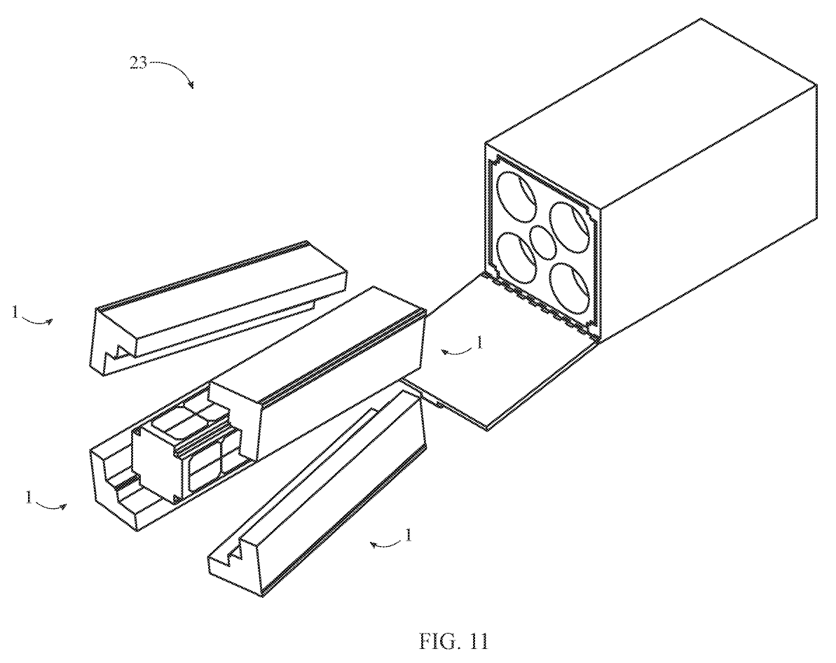

Once launched into the target orbit, the plurality of CubeSat adapters 1 and the transported CubeSat can be deployed from the CubeSat deployer. The plurality of CubeSat adapters 1 and the CubeSat are moved out of the CubeSat deployer by the deployer mechanism into a deployed configuration 23, as can be seen in FIGS. 11 through 13. In the deployed configuration 23, the second leg 9 of an arbitrary CubeSat adapter 24 is positioned offset the first leg 8 of an adjacent CubeSat adapter 25. In other words, the plurality of CubeSat adapters 1 moves away from the CubeSat once exiting the CubeSat deployer. This way, the plurality of CubeSat adapters 1 does not obstruct the deployment of the CubeSat. In other embodiments, the deployed configuration 23 can involve different arrangements of the plurality of CubeSat adapters 1.

As previously discussed, the CubeSat engagement surface 5 is designed to physically engage a corresponding external corner of the CubeSat. As can be seen in FIGS. 1 through 9, an interior body corner 10 of the elongated prismatic body 2 is centrally integrated along the CubeSat engagement surface 5 from the first body end 3 to the second body end 4. The interior body corner 10 corresponds to the interior physical corner formed by the angle shape 7 of the transversal cross-section 21 of the elongated prismatic body 2. In addition, the CubeSat engagement feature 12 is connected into and along the interior body corner 10 so that the CubeSat engagement feature 12 can engage a corner slot of the CubeSat.

Similarly, the deployer engagement surface 6 is designed to physically engage an interior corner of the CubeSat deployer. As can be seen in FIGS. 1 through 7, an exterior body corner 11 of the elongated prismatic body 2 is centrally integrated along the deployer engagement surface 6 from the first body end 3 to the second body end 4. Like the interior body corner 10, the exterior body corner 11 corresponds to an external physical corner formed by the angle shape 7 of the transversal cross-section 21 of the elongated prismatic body 2. In addition, the deployer engagement feature 17 is connected onto and along the exterior body corner 11 so that the deployer engagement feature 17 can engage an interior corner of the CubeSat deployer. The deployer engagement feature 17 is preferably a protruding angle that protrudes from the exterior body corner 11. Further, in some embodiments, the deployer engagement feature 17 can traverse from the first body end 3 to the second body end 4 so that the elongated prismatic body 2 fully engages the interior corner of the CubeSat deployer. In other embodiments, the CubeSat engagement feature 12 and the deployer engagement feature 17 can be rearranged according to different transversal cross-section 21 shapes of the elongated prismatic body 2 that match different CubeSat designs.

As previously discussed, the plurality of CubeSat adapters 1 help fill empty space within the CubeSat adapter that is filled by the target CubeSat. In addition, the plurality of CubeSat adapters 1 need to accommodate the external design of the CubeSat, such as external protrusions and grooves around the CubeSat. As can be seen in FIGS. 1 through 7, to accommodate external corner features of the CubeSat, the CubeSat engagement feature 12 may comprise a rectangular prismatic protrusion 13 and an elongated CubeSat-bracing groove 16. The rectangular prismatic protrusion 13 corresponds to a protrusion that engages a corresponding groove on the exterior corner of the CubeSat. The elongated CubeSat-bracing groove 16 corresponds to a groove that engages a protrusion present within the corresponding external corner groove of the CubeSat. In addition, the rectangular prismatic protrusion 13 comprises a proximal lateral edge 14 and a distal lateral edge 15 corresponding to the opposite lateral edges of the rectangular prismatic protrusion 13.

In general, this embodiment of the CubeSat engagement feature 12 can be implemented as follows: the proximal lateral edge 14 and the distal lateral edge 15 are positioned opposite to each other about the rectangular prismatic protrusion 13, as can be seen in FIGS. 1 through 7. The proximal lateral edge 14 and the distal lateral edge 15 are preferably any two opposite elongated edges of the rectangular prismatic protrusion 13. In addition, the proximal lateral edge 14 is connected into and along the interior body corner 10 to incorporate the rectangular prismatic protrusion 13 onto the CubeSat engagement surface 5. Further, the elongated CubeSat-bracing groove 16 is integrated into and along the distal lateral edge 15 to incorporate the CubeSat-bracing groove along the rectangular prismatic protrusion 13. In other embodiments, different engagement features can be implemented that accommodate different external corner features of the CubeSat.

In addition to accommodating external features of the CubeSat, the plurality of CubeSat adapters 1 accommodates size shortcomings of the CubeSat, such a shorter length. As can be seen in FIGS. 1 through 7, each of the plurality of CubeSat adapters 1 may further comprise a terminal engagement feature 18. The terminal engagement feature 18 is designed to compensate for the shortness of the CubeSat by pushing the CubeSat towards the front of the CubeSat deployer. For example, the terminal engagement feature 18 can be a rectangular prismatic body. The terminal engagement feature 18 also prevents the CubeSat from moving lengthwise within the CubeSat deployer which may cause the center of gravity to change.

In the preferred embodiment, the terminal engagement feature 18 can be implemented as follows: the CubeSat engagement feature 12 and the terminal engagement feature 18 are serially positioned against each other, as can be seen in FIGS. 1 through 7. In other words, the CubeSat engagement feature 12 and the terminal engagement feature 18 are arranged in a linear pattern along the length of the elongated prismatic body 2. The CubeSat engagement feature 12 and the terminal engagement feature 18 are also centrally mounted along the CubeSat engagement surface 5. This positioning allows the CubeSat engagement feature 12 to engage the corresponding corner of the CubeSat while the terminal engagement feature 18 can simultaneously engage the end of the CubeSat. Further, the CubeSat engagement feature 12 is positioned adjacent to the first body end 3 while the terminal engagement feature 18 is positioned adjacent to the second body end 4. In other embodiments, different terminal features can be implemented to help accommodate shorter CubeSats.

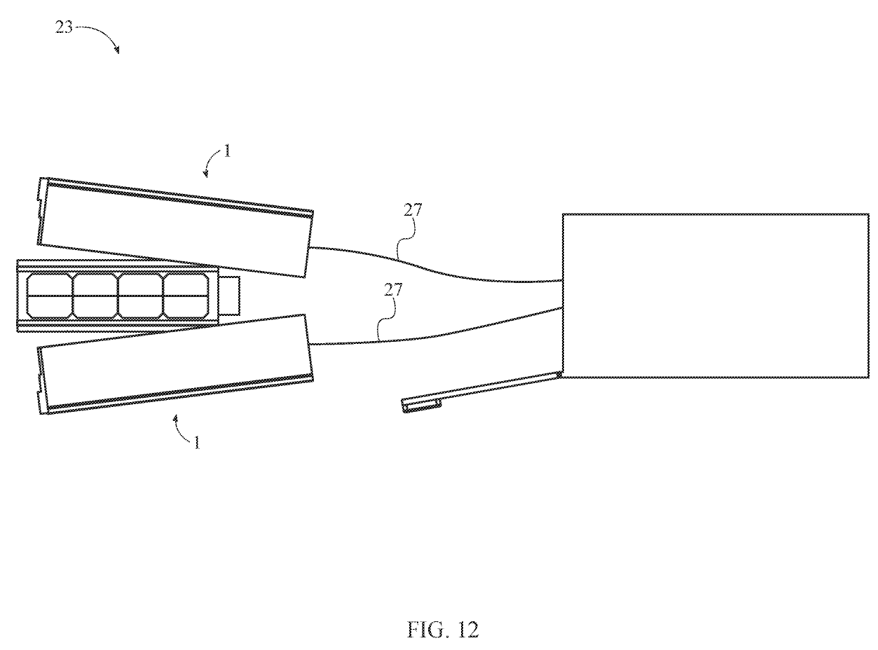

As previously discussed, once the CubeSat is deployed by the CubeSat deployer, the plurality of CubeSat adapters 1 is also deployed along with the CubeSat. Due to the current limitation of space launch technology, the plurality of CubeSat adapters 1 is left on space which can increase space debris in the long run. As can be seen in FIG. 12, to reduce the amount of debris generated by the launch of the CubeSat, the present invention may further comprise a plurality of debris-preventing tethers 27. The plurality of debris-preventing tethers 27 corresponds to several tethers that secure the plurality of CubeSat adapters 1 to the CubeSat deployer. The plurality of debris-preventing tethers 27 includes several tethers longer than the length of the plurality of CubeSat adapters 1 that keep the plurality of CubeSat adapters 1 attached to the CubeSat deployer. The plurality of CubeSat adapters 1 is tethered together by the plurality of debris-preventing tethers 27. For example, each CubeSat adapter can be individually tethered to the interior of the CubeSat deployer so that the plurality of CubeSat adapters 1 can freely move once the CubeSat is deployed.

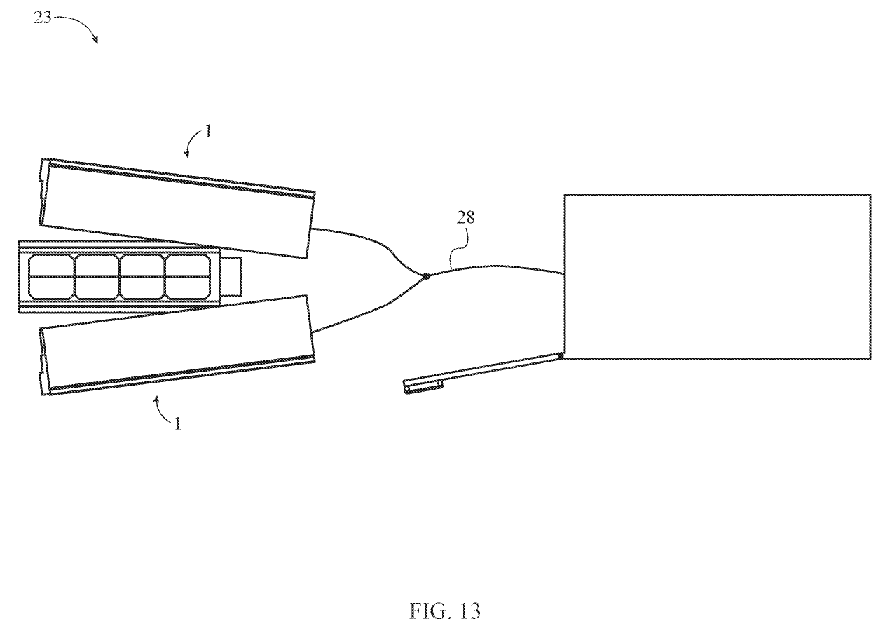

In an alternative embodiment, the present invention may further comprise at least one deployer-anchoring tether 28 that secures all the plurality of CubeSat adapters 1 together with the CubeSat deployer, as can be seen in FIG. 13. The at least one deployer-anchoring tether 28 is designed to secure the plurality of CubeSat adapters 1 together once the CubeSat is deployed without obstructing the deployment of the CubeSat. Further, the at least one deployer-anchoring tether 28 can be tethered to the plurality of CubeSat adapters 1 in such a way that the plurality of CubeSat adapters 1 can separate from the CubeSat when deployed. In other embodiments, different tethering mechanisms can be implemented to reduce the amount of space debris generated after the deployment of the CubeSat.

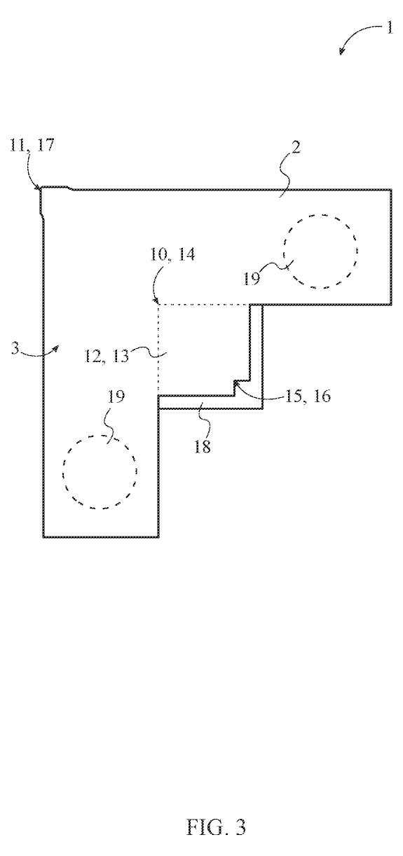

As previously discussed, the present invention also enables the adjustment of the overall mass of the system if the CubeSat fails to meet the initially manifested mass. As can be seen in FIG. 3, each of the plurality of CubeSat adapters 1 may further comprise at least one ballasting weight 19 that helps add additional mass to the system if necessary. Further, the at least one ballasting weight 19 is integrated into the elongated adapter body to increase the mass of the corresponding CubeSat adapter. The overall weight of the at least one ballasting weight 19 depends on the necessary mass that corresponding CubeSat adapter needs to add to the system. Further, the overall position of the at least one ballasting weight 19 along the corresponding elongated adapter body depends on the target center of gravity of the system. In other embodiments, different mechanisms can be implemented to adjust the center of gravity of the system.

Although the invention has been explained in relation to its preferred embodiment, it is to be understood that many other possible modifications and variations can be made without departing from the spirit and scope of the invention.

What is claimed is:

1. An adapter system for a CubeSat deployer comprising:
a plurality of CubeSat adapters;
each of the plurality of CubeSat adapters comprising an elongated prismatic body, a CubeSat engagement feature, and a deployer engagement feature;
the elongated prismatic body comprising a first body end, a second body end, a CubeSat engagement surface, and a deployer engagement surface;
the CubeSat engagement surface and the deployer engagement surface being laterally positioned along the elongated prismatic body;
the CubeSat engagement surface and the deployer engagement surface being positioned opposite to each other about the elongated prismatic body;
the CubeSat engagement feature being centrally mounted along the CubeSat engagement surface;
the deployer engagement feature being centrally mounted along the deployer engagement surface;
the elongated prismatic body for each of the plurality of CubeSat adapters being positioned parallel with a central CubeSat-traversing axis; and
the elongated prismatic body for each of the plurality of CubeSat adapters being radially distributed about the central CubeSat-traversing axis.

2. The adapter system for a CubeSat deployer as claimed in claim 1 further comprising:
a transversal cross-section of the elongated prismatic body being an angle shape;
the angle shape comprising a first leg and a second leg; and
the first leg and the second being connected perpendicular and adjacent to each other.

3. The adapter system for a CubeSat deployer as claimed in claim 2 further comprising:
wherein the plurality of CubeSat adapters is arranged in a primed configuration; and
the second leg of an arbitrary CubeSat adapter being positioned parallel and against the first leg of an adjacent CubeSat adapter, wherein the arbitrary CubeSat adapter and the adjacent CubeSat adapter are any adjacent pair of CubeSat adapters from the plurality of CubeSat adapters.

4. The adapter system for a CubeSat deployer as claimed in claim 2 further comprising:
wherein the plurality of CubeSat adapters is arranged in a deployed configuration; and
the second leg of an arbitrary CubeSat adapter being positioned offset the first leg of an adjacent CubeSat adapter, wherein the arbitrary CubeSat adapter and the adjacent CubeSat adapter are any adjacent pair of CubeSat adapters from the plurality of CubeSat adapters.

5. The adapter system for a CubeSat deployer as claimed in claim 1 further comprising:
a transversal cross-section of the elongated prismatic body being an angle shape;
an interior body corner of the elongated prismatic body being centrally integrated along the CubeSat engagement surface from the first body end to the second body end;
an exterior body corner of the elongated prismatic body being centrally integrated along the deployer engagement surface from the first body end to the second body end;
the CubeSat engagement feature being connected into and along the interior body corner; and
the deployer engagement feature being connected onto and along the exterior body corner.

6. The adapter system for a CubeSat deployer as claimed in claim 5, wherein the deployer engagement feature is a protruding angle.

7. The adapter system for a CubeSat deployer as claimed in claim 5 further comprising:
the CubeSat engagement feature comprising a rectangular prismatic protrusion and an elongated CubeSat-bracing groove;
the rectangular prismatic protrusion comprising a proximal lateral edge and a distal lateral edge;
the proximal lateral edge and the distal lateral edge being positioned opposite to each other about the rectangular prismatic protrusion;
the proximal lateral edge being connected into and along the interior body corner; and
the elongated CubeSat-bracing groove being integrated into and along the distal lateral edge.

8. The adapter system for a CubeSat deployer as claimed in claim 1 further comprising:
each of the plurality of CubeSat adapters further comprising a terminal engagement feature;
the CubeSat engagement feature and the terminal engagement feature being serially positioned against each other;
the CubeSat engagement feature and the terminal engagement feature being centrally mounted along the CubeSat engagement surface;
the CubeSat engagement feature being positioned adjacent to the first body end; and
the terminal engagement feature being positioned adjacent to the second body end.

9. The adapter system for a CubeSat deployer as claimed in claim 8, wherein the terminal engagement feature is a rectangular prismatic body.

10. The adapter system for a CubeSat deployer as claimed in claim 1, wherein the deployer engagement feature traverses from the first body end to the second body end.

11. The adapter system for a CubeSat deployer as claimed in claim 1 further comprising:
a plurality of debris-preventing tethers; and
the plurality of CubeSat adapters being tethered together by the plurality of debris-preventing tethers.

12. The adapter system for a CubeSat deployer as claimed in claim 1 further comprising:
at least one deployer-anchoring tether; and
the at least one deployer-anchoring tether being tethered to the plurality of CubeSat adapters.

13. The adapter system for a CubeSat deployer as claimed in claim 1 further comprising:
each of the plurality of CubeSat adapters further comprising at least one ballasting weight; and
the at least one ballasting weight being integrated into the elongated adapter body.

14. An adapter system for a CubeSat deployer comprising:
a plurality of CubeSat adapters;
each of the plurality of CubeSat adapters comprising an elongated prismatic body, a CubeSat engagement feature, a deployer engagement feature, and at least one ballasting weight;
the elongated prismatic body comprising a first body end, a second body end, a CubeSat engagement surface, and a deployer engagement surface;
a transversal cross-section of the elongated prismatic body being an angle shape;
the angle shape comprising a first leg and a second leg;
the CubeSat engagement surface and the deployer engagement surface being laterally positioned along the elongated prismatic body;
the CubeSat engagement surface and the deployer engagement surface being positioned opposite to each other about the elongated prismatic body;
the CubeSat engagement feature being centrally mounted along the CubeSat engagement surface;
the deployer engagement feature being centrally mounted along the deployer engagement surface;
the deployer engagement feature traversing from the first body end to the second body end;
the elongated prismatic body for each of the plurality of CubeSat adapters being positioned parallel with a central CubeSat-traversing axis;
the elongated prismatic body for each of the plurality of CubeSat adapters being radially distributed about the central CubeSat-traversing axis;
the at least one ballasting weight being integrated into the elongated adapter body; and
the first leg and the second being connected perpendicular and adjacent to each other.

15. The adapter system for a CubeSat deployer as claimed in claim 14 further comprising:
wherein the plurality of CubeSat adapters is arranged in a primed configuration; and
the second leg of an arbitrary CubeSat adapter being positioned parallel and against the first leg of an adjacent CubeSat adapter, wherein the arbitrary CubeSat adapter and the adjacent CubeSat adapter are any adjacent pair of CubeSat adapters from the plurality of CubeSat adapters.

16. The adapter system for a CubeSat deployer as claimed in claim 14 further comprising:
wherein the plurality of CubeSat adapters is arranged in a deployed configuration; and
the second leg of an arbitrary CubeSat adapter being positioned offset the first leg of an adjacent CubeSat adapter, wherein the arbitrary CubeSat adapter and the adjacent CubeSat adapter are any adjacent pair of CubeSat adapters from the plurality of CubeSat adapters.

17. The adapter system for a CubeSat deployer as claimed in claim 14 further comprising:
the CubeSat engagement feature comprising a rectangular prismatic protrusion and an elongated CubeSat-bracing groove;
the rectangular prismatic protrusion comprising a proximal lateral edge and a distal lateral edge;
a transversal cross-section of the elongated prismatic body being an angle shape;
the deployer engagement feature being a protruding angle;
the proximal lateral edge and the distal lateral edge being positioned opposite to each other about the rectangular prismatic protrusion;
an interior body corner of the elongated prismatic body being centrally integrated along the CubeSat engagement surface from the first body end to the second body end;
an exterior body corner of the elongated prismatic body being centrally integrated along the deployer engagement surface from the first body end to the second body end;
the CubeSat engagement feature being connected into and along the interior body corner;
the deployer engagement feature being connected onto and along the exterior body corner;
the proximal lateral edge being connected into and along the interior body corner; and
the elongated CubeSat-bracing groove being integrated into and along the distal lateral edge.

18. The adapter system for a CubeSat deployer as claimed in claim 14 further comprising:
each of the plurality of CubeSat adapters further comprising a terminal engagement feature;
the terminal engagement feature being a rectangular prismatic body;
the CubeSat engagement feature and the terminal engagement feature being serially positioned against each other;
the CubeSat engagement feature and the terminal engagement feature being centrally mounted along the CubeSat engagement surface;
the CubeSat engagement feature being positioned adjacent to the first body end; and
the terminal engagement feature being positioned adjacent to the second body end.

19. The adapter system for a CubeSat deployer as claimed in claim 14 further comprising:
a plurality of debris-preventing tethers; and
the plurality of CubeSat adapters being tethered together by the plurality of debris-preventing tethers.

20. The adapter system for a CubeSat deployer as claimed in claim 14 further comprising:
at least one deployer-anchoring tether; and
the at least one deployer-anchoring tether being tethered to the plurality of CubeSat adapters.
